(19) United States
(12) Patent Application Publication
(10) Pub. No.: US 2016/0183594 A1
(43) Pub. Date: Jun. 30, 2016

(54) ELECTRONIC CIGARETTE

(71) Applicant: KIMREE HI-TECH INC., Tortola (VG)

(72) Inventor: Qiuming Liu, Shenzhen, Guangdong (CN)

(21) Appl. No.: 14/910,249

(22) PCT Filed: Aug. 6, 2013
(86) PCT No.: PCT/CN2013/080913

§ 371 Date: Feb. 4, 2016

(51) Int. Cl. A24F 47/00; H05B 3/06; H05B 3/03

(52) U.S. Cl. CPC A24F 47/008; H05B 3/03; H05B 3/06

(57) ABSTRACT

An electronic cigarette comprises an atomizer, a power supply rod and a connecting structure, the connecting structure comprises a first connecting piece and a second connecting piece; the first connecting piece is provided with a coupling groove; the coupling groove is provided with at least one first accommodation position, and the second connecting piece is correspondingly provided with at least one second accommodation position; further comprises an elastic piece with a convex portion and a guide channel; when being fastened, the elastic piece is inserted along the guide channel, and is rotated to make the convex portion be pressed by the fastening area and retracted; and when being rotated to the first accommodation position corresponding to the second accommodation position, the convex portion recovers from deformation. The connecting structure provides reliable connection, and convenient replacement of a fastening structure, thus improves user experience.

### TECHNICAL FIELD

The present application relates to the technical field of electric heating products, and more particularly, relates to an electronic cigarette.

### BACKGROUND

An electronic cigarette generally includes an atomizer and a battery rod. In the prior art, most of the connections between the atomizers and the battery rods are threaded connections and directly plugged connections. When using the threaded connection, the misplacement is prone to occur, the connection is poor reliability, and it is inconvenient for disassembly; when using the directly plugged connection, there is a unreliable defect, and the structure is not simple, inconvenient to use, which is bad for smoking cessation, the user experience is poor.

### BRIEF SUMMARY

The objective of the present application is to provide an electronic cigarette with convenient assembly and reliable connection, aiming at the drawbacks that the connection between the above-mentioned battery rod and the atomizer is complicate and unreliable in the prior art.

In accordance with one aspect of the present application, there is provided an electronic cigarette, comprising an atomizer and a power supply rod; a connecting structure is disposed at a joint of the atomizer and the power supply rod, the connecting structure comprising a first connecting piece and a second connecting piece, the first connecting piece and the second connecting piece are docked with each other; the first connecting piece is provided with a coupling groove for insertion of the second connecting piece; an inner wall of the coupling groove is provided with at least one first accommodation position, and the second connecting piece is correspondingly provided with at least one second accommodation position; further comprising an elastic piece with a convex portion protruding from the first accommodation position radially inward or protruding from the second accommodation position radially outward a guide channel is disposed at one side of the second accommodation position or the first accommodation position; when being fastened, the elastic piece is inserted along the guide channel, and is rotated to make the convex portion be pressed by a fastening surface and then be retracted; and when being rotated to the first accommodation position corresponding to the second accommodation position, the convex portion recovers to normal state from deformation, and rebounds into the common space formed by the first accommodation position and the second accommodation position.

A first electrode is provided on the first connecting piece, the first accommodation position is provided on a circumferential sidewall of the first electrode; a second electrode is provided on the second connecting piece, the second accommodation position is provided on a circumferential sidewall of the second electrode.

The elastic piece is a circlip, the circlip is a ring structure provided with an opening, and the convex portion is a first convex rib protruding from a part of the circlip radially inward.

The first accommodation position is a through-hole, a first ring-shaped groove is deposited at an exterior circumference of the first electrode, the first accommodation position is positioned in the first ring-shaped groove, the circlip is sleeved in the first ring-shaped groove, and the first convex rib is passed through and protruded from the first accommodation position radially inward.

The second accommodation position is a concave position or a through-hole; and when being rotated to the first accommodation position corresponding to the second accommodation position, the first convex rib is rebounded into the common space formed by the first accommodation position and the second accommodation position.

The guide channel is a first guide portion provided on the second electrode; the first guide portion is a chamfer provided on one end of the second electrode, the end is toward the first connecting piece; or the first guide portion is a flat or a concave provided on the second electrode and axially extended to an end surface of the second electrode, the end surface is toward the first connecting piece.

The elastic piece is a spring wire, the spring wire is provided with a closed ring structure, and the convex portion is a second convex rib protruding from a part of the spring wire radially outward.

The second accommodation position is a through-hole, a second ring-shaped groove is deposited at an inner circumference of the second electrode, the second accommodation position is positioned in the second ring-shaped groove, the spring wire is sleeved in the second ring-shaped groove, and the second convex rib is passed through and protruded from the second accommodation position radially outward.

The first accommodation position is a concave position or a through-hole; and when being rotated to the second accommodation position corresponding to the first accommodation position, the second convex rib is rebounded into the common space formed by the first accommodation position and the second accommodation position.

The guide channel is a second guide portion provided on the first electrode; the second guide portion is a chamfer provided on one end of the first electrode, the end is toward the second connecting piece; or the second guide portion is a concave provided on the first electrode and axially extended to an end surface of the first electrode, the end surface is toward the second connecting piece.

The number of the first accommodation positions, the number of the second accommodation positions and the number of the convex portions are all two, and the first accommodation positions , the second accommodation positions and the convex portions are evenly distributed separately.

The convex portion is protruded from the first accommodation position or the second accommodation position for a distance of 3 mm to 10 mm.

When implementing the electronic cigarette of the present application, the following advantageous can be achieved: by providing the first accommodation position in the first connecting piece, the second connecting piece is correspondingly provided with the second accommodation position, and providing the elastic piece with a convex portion radially protruding inward from the first accommodation position or radially protruding outward from the second accommodation position, when being fastened, it just needs to make the convex portion rebound into the common space formed by the first accommodation position and the second accommodation position, so as to achieve the connection between the first connecting piece and the second connecting piece. The utility model has the advantages of the simple structure and the convenient connection.

### BRIEF DESCRIPTION OF THE DRAWINGS

The present application will be further described with reference to the accompanying drawings and embodiments in the following, in the accompanying drawings:

FIG. 1 illustrates a schematic view of the decomposition structure of an electronic cigarette according to a first embodiment of the present application;

FIG. 2 illustrates a schematic view of the first electrode according to a first embodiment of the present application;

FIG. 3 illustrates a schematic view of the circlip according to a first embodiment of the present application;

FIG. 4 illustrates a schematic view of the second electrode according to a first embodiment of the present application;

FIG. 5 illustrates a partial cutaway view of the decomposition structure of an electronic cigarette according to a first embodiment of the present application;

FIG. 6 illustrates a schematic view of the decomposition structure of an electronic cigarette according to a second embodiment of the present application;

FIG. 7 illustrates a schematic view of the first electrode according to a second embodiment of the present application;

FIG. 8 illustrates a schematic view of the circlip according to a second embodiment of the present application;

FIG. 9 illustrates a schematic view of the second electrode according to a second embodiment of the present application;

FIG. 10 illustrates a partial cutaway view of the decomposition structure of an electronic cigarette according to a second embodiment of the present application.

### DETAILED DESCRIPTION OF THE PREFERRED EMBODIMENT

In order to make the technical features, the propose and the technical effect of the present application more clearly, the present application will now be described in detail with reference to the accompanying drawings and embodiments.

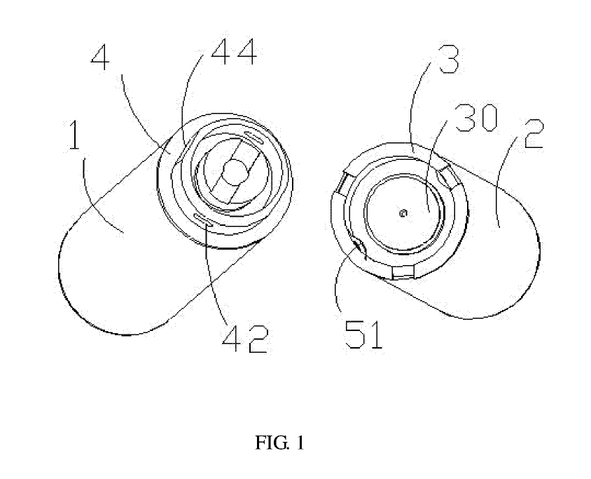

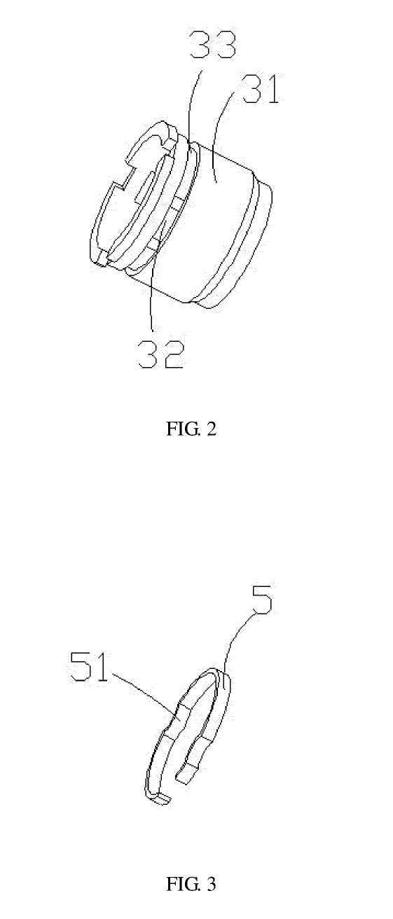

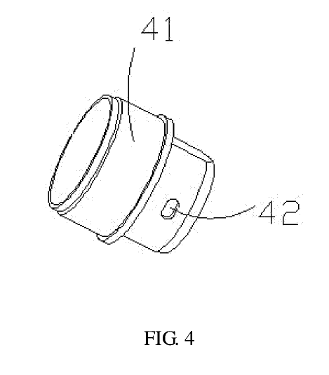

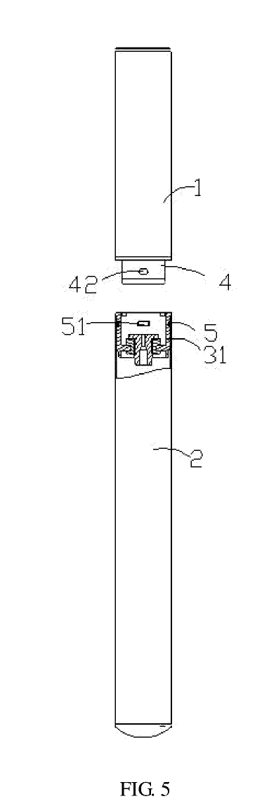

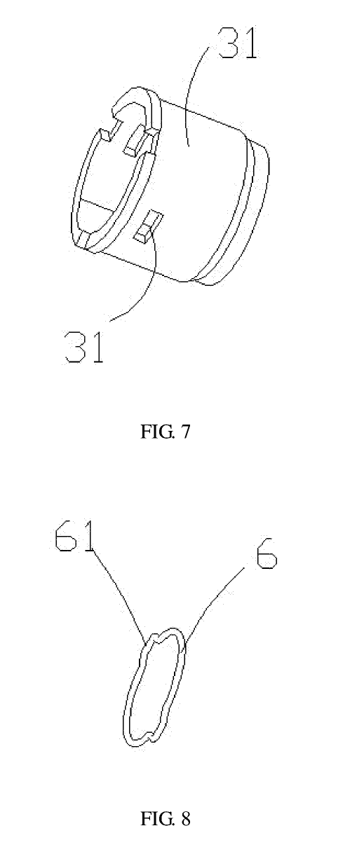

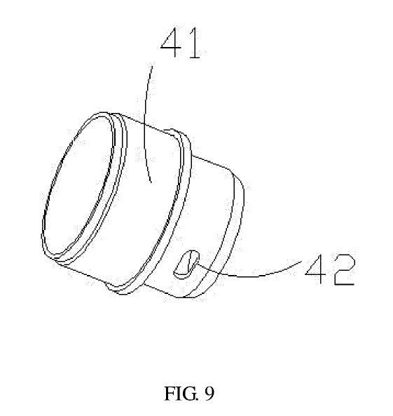

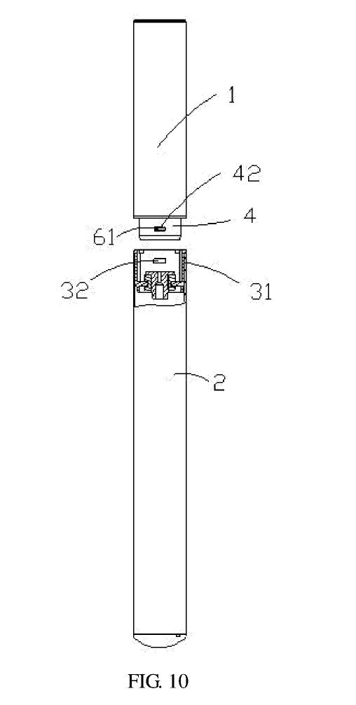

As shown in FIG. 1 to FIG. 10, according to a first embodiment of the present application, there is provided an electronic cigarette comprising an atomizer 1 and a power supply rod 2, a connecting structure is disposed at the joint of the atomizer 1 and the power supply rod 2, the connecting structure comprising a first connecting piece 3 and a second connecting piece 4, the first connecting piece 3 and the second connecting piece 4 are docked with each other; the first connecting piece 3 is provided with a coupling groove 30 for insertion of the second connecting piece 4; the inner wall of the coupling groove 30 is provided with at least one first accommodation position 32, and the second connecting piece 4 is correspondingly provided with at least one second accommodation position 42; further comprising an elastic piece with a convex portion protruding from the first accommodation position 32 radially inward or protruding from the second accommodation position 42 radially outward; a guide channel is disposed at one side of the second accommodation position 42 or the first accommodation position 32; when being fastened, the elastic piece is inserted along the guide channel, and is rotated to make the convex portion be pressed by a fastening surface and then be retracted; and when being rotated to the first accommodation position 32 corresponding to the second accommodation position 42, the convex portion recovers to normal state from deformation, and rebounds into the common space formed by the first accommodation position 32 and the second accommodation position 42.

It could be understood that, when the guide channel is disposed at one side of the first accommodation position 32, the fastening surface is the inner wall of the coupling groove 30, the inner wall is between the first accommodation position 32 and the guide channel. When the guide channel is disposed at one side of the second accommodation position 42, the fastening surface is the exterior wall of the second connecting piece 4, the exterior wall is between the second accommodation position 42 and the guide channel.

In the present application, it just needs to provide with the first accommodation position 32, the second accommodation position 42 and the elastic piece with a convex portion radially protruding inward from the first accommodation position 32 or radially protruding outward from the second accommodation position 42, so as to complete the firm fastening and simple structure. And because the fastening process is inserting the second connecting piece 4 into the first connecting piece 3 and rotating, so that the fastening process is simple and convenient.

Specifically, a first electrode 31 is provided on the first connecting piece 3, the first accommodation position 32 is provided on a circumferential sidewall of the first electrode 31; a second electrode 41 is provided on the second connecting piece 4, the second accommodation position 42 is provided on a circumferential sidewall of the second electrode 41. The first electrode 31 and the second electrode 41 both are hollow rings, wherein a buckling groove is formed inside the hollow ring of the first connecting piece 3. The first electrode 31 is interference-fit inserted in an outer sleeve of the atomizer 1 or an outer sleeve of a power supply rod 2, similarly, the second electrode 41 is interference-fit inserted in the outer sleeve of a power supply rod 2 or the outer sleeve of the atomizer 1.

For the purpose of firmly fastening of the first connecting piece 3 and the second connecting piece 4, when the convex portion rebounds into the common space formed by the first accommodation position 32 and the second accommodation position 42, the convex portion is protruded from the first accommodation position 32 or the second accommodation position 42 for the distance of 3 mm-10 mm. Preferably, the convex portion is protruded from the first accommodating position 32 or the second accommodation position 42 for the distance of 5 mm in the present application.

The number of the first accommodation positions 32, the number of the second accommodation positions 42 and the number of the convex portions are all two, and the first accommodation positions 32, the second accommodation positions 42 and the convex portions are evenly distributed separately. The elastic piece can be a circlip 5, a spring wire 6, a shrapnel or other elastic elements. In the present application, there are following several embodiments for types of the elastic piece and installation methods (the present application will describe in the case that the first electrode 31 is electrically connected to the battery of the power supply rod 2 and the second electrode 41 is electrically connected to the atomizing component of the atomizer 1).

A first embodiment: As shown in FIG. 1 to FIG. 5, the elastic piece is the circlip 5, the circlip 5 is a ring structure provided with an opening, and the convex portion is a first convex rib 51 protruding from a part of the circlip 5 radially inward. At this moment, the first accommodation position 32 is a through-hole, a first ring-shaped groove 33 is deposited at a circumference of an exterior sidewall of the first electrode 31, the first accommodation position 32 is positioned in the first ring-shaped groove 33, the circlip 5 is sleeved in the first ring-shaped groove 33, the first convex rib 51 is passed through and protruded from the first accommodation position 32 radially inward. Specifically, the second accommodation position 42 is a concave position or a through-hole; and when being rotated to the first accommodation position 32 corresponding to the second accommodation position 42, the first convex rib 51 is rebounded into the common space formed by the first accommodation position 32 and the second accommodation position 42.

Preferably, for the purpose of convenient manufacture, the first accommodation position 32 and the second accommodation position 42 both are through-holes, and the through-holes are rectangular holes or waist-shaped holes, so convenient for the first convex rib 51 to get through the through-holes and be contained in the through-holes.

As shown in FIG. 1, the guide channel is a first guide portion 44 provided on the second electrode 41, the first guide portion 44 is a chamfer provided on one end of the second electrode 41, the end is toward the first connecting piece 3, in the process of fastening, the first convex rib 51 can be compressed slowly through the chamfer until the second electrode 41 is inserted into the first electrode 31, it is convenient to inserting. The chamfer is a beveling or a corner rounding. Or the first guide portion 44 is a flat or a concave provided on the second electrode 41 and axially extended to an end surface of the second electrode 41, the end surface is toward the first connecting piece 3. Because of the flat or the concave, the radial length here of the second electrode 41 decreases, so that the second electrode 41 can be inserted into the first electrode 31, in the case, the first convex rib 51 is not compressed or the amount of compression is small. Afterwards, rotating the second electrode 41 or the first electrode 31 to make the first accommodation position 32 and the second accommodation position 42 correspond to each other, and the first convex rib 51 ejects to achieve the fastening of the first connecting piece 3 and the second connecting piece 4.

In the present application, it is preferably that the first guide portion 44 is the flat which is axially extended to an end surface of the second electrode 41, the end surface is toward the first connecting piece 3.

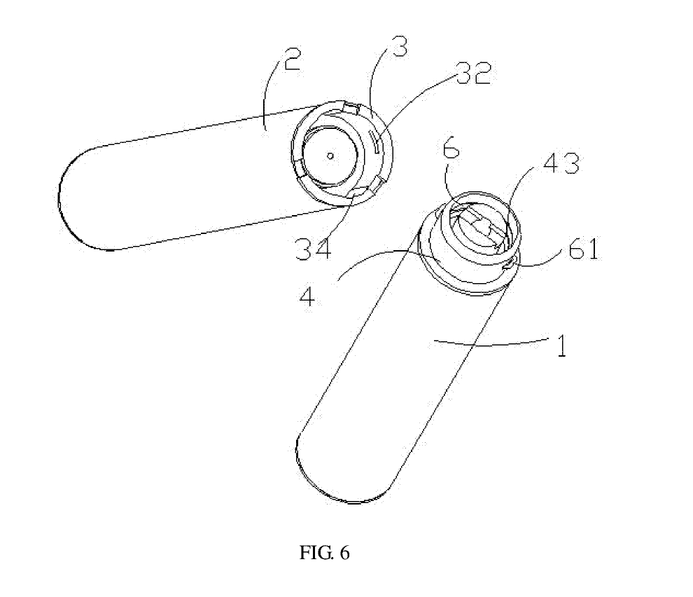

A second embodiment: As shown in FIG. 6 to FIG. 10, the elastic piece is a spring wire 6, the spring wire 6 is provided with a closed ring structure, the convex portion is a second convex rib 61 protruding from a part of the spring wire 6 radially outward.

The second accommodation position 42 is a through-hole, a second ring-shaped groove 43 is deposited at an inner circumference of the second electrode 41, the second accommodation position 42 is positioned in the second ring-shaped groove 43, the spring wire 6 is sleeved in the second ring-shaped groove 43, the second convex rib 61 is passed through and protruded from the second accommodation position 42 radially outward. The first accommodation position 32 is a concave position or a through-hole; and when being rotated to the second accommodation position 42 corresponding to the first accommodation position 32, the second convex rib 61 is rebounded into the common space formed by the first accommodation position 32 and the second accommodation position 42.

Similarly, for the purpose of convenient manufacture, the first accommodation position 32 and the second accommodation position 42 both are through-holes, and the through-holes are rectangular holes or waist-shaped holes, so convenient for the second convex rib 61 to get through the through-holes and be contained in the through-holes.

As shown in FIG. 6, the guide channel is a second guide portion 34 provided on the first electrode 31; the second guide portion 34 is a chamfer provided on one end of the first electrode 31, the end is toward the second connecting piece 4; or the second guide portion 34 is a concave provided on the first electrode 31 and axially extended to an end surface of the first electrode 31, the end surface is toward the second connecting piece 4.

Preferably, the second guide portion 34 is the concave which is axially extended to an end surface of the first electrode 31, the end surface is toward the second connecting piece 4.

In summary, by providing the first accommodation position 32 and the second accommodation position 42, and the positions of the first accommodation position 32 and the second accommodation position 42 are corresponding; and providing the elastic piece with a convex portion radially protruding inward from the first accommodation position 32 or radially protruding outward from the second accommodation position 42, when being fastened, the convex portion rebounds into the common space formed by the first accommodation position 32 and the second accommodation position 42. The utility model has the advantages of the simple structure, the firm fastening and the convenient connection.

Although the present application is illustrated with the embodiments accompanying the drawings, the present application is not limited to the above-mentioned specific embodiments, and the above-mentioned embodiments are only for illustration, not for limitation. In the inspiration of the present application, those skilled in the art may make many modifications, without going beyond the purpose and the scope the claims intend to protect of the present application; all these belong to the protection of the present application.

1. An electronic cigarette comprising an atomizer (1) and a power supply rod (2); a connecting structure being disposed at a joint of the atomizer (1) and the power supply rod (2), the connecting structure comprising a first connecting piece (3) and a second connecting piece (4), the first connecting piece (3) and the second connecting piece (4) being docked with each other;
wherein the first connecting piece (3) is provided with a coupling groove (30) for insertion of the second connecting piece (4); an inner wall of the coupling groove (30) is provided with at least one first accommodation position (32), and the second connecting piece (4) is correspondingly provided with at least one second accommodation position (42);
the connecting structure further comprising an elastic piece with a convex portion protruding from the first accommodation position (32) radially inward or protruding from the second accommodation position (42) radially outward;
wherein a guide channel is disposed at one side of the second accommodation position (42) or the first accommodation position (32); and
when being fastened, the elastic piece is inserted along the guide channel, and is rotated to make the convex portion be pressed by a fastening surface and then be retracted; and when being rotated to the first accommodation position (32) corresponding to the second accommodation position (42), the convex portion recovers to normal state from deformation, and rebounds into the common space formed by the first accommodation position (32) and the second accommodation position (42).

2. The electronic cigarette according to claim 1, wherein a first electrode (31) is provided on the first connecting piece (3), the first accommodation position (32) is provided on a circumferential sidewall of the first electrode (31); a second electrode (41) is provided on the second connecting piece (4), the second accommodation position (42) is provided on a circumferential sidewall of the second electrode (41).

3. The electronic cigarette according to claim 1 or 2, wherein the elastic piece is a circlip (5), the circlip (5) is a ring structure provided with an opening, and the convex portion is a first convex rib (51) protruding from a part of the circlip (5) radially inward.

4. The electronic cigarette according to claim 3, wherein the first accommodation position (32) is a through-hole, a first ring-shaped groove (33) is deposited at an exterior circumference of the first electrode (31), the first accommodation position (32) is positioned in the first ring-shaped groove (33), the circlip (5) is sleeved in the first ring-shaped groove (33), and the first convex rib (51) is passed through and protruded from the first accommodation position (32) radially inward.

5. The electronic cigarette according to claim 4, wherein the second accommodation position (42) is a concave position or a through-hole;
when being rotated to the first accommodation position (32) corresponding to the second accommodation position (42), the first convex rib (51) is rebounded into the common space formed by the first accommodation position (32) and the second accommodation position (42).

6. The electronic cigarette according to claim 4, wherein the guide channel is a first guide portion (44) provided on the second electrode (41); the first guide portion (44) is a chamfer provided on one end of the second electrode (41), the end is toward the first connecting piece (3); or the first guide portion (44) is a flat or a concave provided on the second electrode (41) and axially extended to an end surface of the second electrode, the end surface is toward the first connecting piece (3).

7. The electronic cigarette according to claim 2, wherein the elastic piece is a spring wire (6), the spring wire (6) is provided with a closed ring structure, and the convex portion is a second convex rib (61) protruding from a part of the spring wire (6) radially outward.

8. The electronic cigarette according to claim 7, wherein the second accommodation position (42) is a through-hole, a second ring-shaped groove (43) is deposited at an inner circumference of the second electrode (41), and the second accommodation position (42) is positioned in the second ring-shaped groove (43), the spring wire (6) is sleeved in the second ring-shaped groove (43), the second convex rib (61) is passed through and protruded from the second accommodation position (42) radially outward.

9. The electronic cigarette according to claim 8, wherein the first accommodation position (32) is a concave position or a through-hole;
when being rotated to the second accommodation position (42) corresponding to the first accommodation position (32), the second convex rib (61) is rebounded into the common space formed by the first accommodation position (32) and the second accommodation position (42).

10. The electronic cigarette according to claim 8, wherein the guide channel is a second guide portion (34) provided on the first electrode (31); the second guide portion (34) is a chamfer provided on one end of the first electrode (31), the end is toward the second connecting piece (4); or the second guide portion (34) is a concave provided on the first electrode (31) and axially extended to an end surface of the first electrode (31), the end surface is toward the second connecting piece (4).

11. The electronic cigarette according to claim 1, wherein the number of the first accommodation positions (32), the number of the second accommodation positions (42) and the number of the convex portions are all two, and the first accommodation positions, the second accommodation positions and the convex portions are evenly distributed separately.

12. The electronic cigarette according to claim 1, wherein the convex portion is protruded from the first accommodation position (32) or the second accommodation position (42) for a distance of 3 mm to 10 mm.

13. An electronic cigarette comprising an atomizer (1) and a power supply rod (2); a connecting structure being disposed at a joint of the atomizer (1) and the power supply rod (2), the connecting structure comprising a first connecting piece (3) and a second connecting piece (4), the first connecting piece (3) and the second connecting piece (4) being docked with each other;
wherein the first connecting piece (3) is provided with a coupling groove (30) for insertion of the second connecting piece (4); an inner wall of the coupling groove (30) is provided with at least one first accommodation position (32), and the second connecting piece (4) is correspondingly provided with at least one second accommodation position (42);
the connecting structure further comprising an elastic piece with a convex portion protruding from the first accommodation position (32) radially inward or protruding from the second accommodation position (42) radially outward;
wherein a guide channel is disposed at one side of the second accommodation position (42) or the first accommodation position (32);
wherein the number of the first accommodation positions (32), the number of the second accommodation positions (42) and the number of the convex portions are all two, and the first accommodation positions, the second accommodation positions and the convex portions are evenly distributed separately;
wherein the convex portion is protruded from the first accommodation position (32) or the second accommodation position (42) for a distance of 3 mm to 10 mm; and
when being fastened, the elastic piece is inserted along the guide channel, and is rotated to make the convex portion be pressed by a fastening surface and then be retracted; and when being rotated to the first accommodation position (32) corresponding to the second accommodation position (42), the convex portion recovers to normal state from deformation, and rebounds into the common space formed by the first accommodation position (32) and the second accommodation position (42).
